(19) United States
(12) Patent Application Publication
(10) Pub. No.: US 2006/0224410 A1
(43) Pub. Date: Oct. 5, 2006

(54) Carbon dioxide emission trade system

(76) Inventors: Masaharu Kimoto, Kyoto-shi (JP); Yoshiyuki Katayama, Osaka (JP)

Correspondence Address: FLYNN THIEL BOUTELL & TANIS, P.C., 2026 RAMBLING ROAD, KALAMAZOO, MI, 49008-1631, US

(21) Appl. No.: 11/350,389

(22) Filed: Feb. 8, 2006

(30) Foreign Application Priority Data
Feb. 18, 2005 (JP) 2005-42284

(51) Int. Cl. G06Q 99/00

(52) U.S. Cl. 705/1

(57) ABSTRACT

A carbon dioxide emission right trade system of the present invention comprises: a database memory means which stores carbon dioxide fixation technologies using seawater with grade, technology evaluation scores, exploitable seas and areas of the ocean; and an input means of a value amount of carbon dioxide emission and a selected carbon dioxide fixation technology; and a processing means for the amount of carbon dioxide emission to calculate the product of the evaluation score and the square of land referring to above database; and a comparing means between the input data of numerical amount of emission and the product data calculated by processing means; and an output means that displays the technology of which product data is bigger than the input data. The input means or the output means are connected to telecommunication system like an Internet, and the system can be accessible from anywhere in the world where the Internet system is available.

### FIELD OF THE INVENTION

This invention relates to a carbon dioxide emission right trade system, more particularly, to a trade system which promotes development of carbon dioxide fixation technologies and also promotes a carbon dioxide emission right trade, and consequently, contributes to solving environmental issues, such as global temperature increase called global warming.

Global warming is an increase in the average temperature of the Earth's atmosphere and oceans, which attributes much of the recently observed and projected global warming to a human-induced intensification of the greenhouse effect. The increased volumes of carbon dioxide and other greenhouse gases released mainly by the burning of fossil fuels, and, to a lesser extent, land clearing and agriculture, are the primary sources of warming.

The natural greenhouse effect keeps the Earth 30° C. warmer than it would be; adding carbon dioxide to an atmosphere, with no other changes, will make a planet's surface warmer. Temperature change is just one aspect of the broader subject of human-induced climate change.

The UN Intergovernmental Panel on Climate Change (IPCC) explicitly endorsed by the national science academies of the G8 nations, is that the average global temperature has risen 0.6±0.2° C. since the late 19th century, and that it is likely that “most of the warming observed over the last 50 years is attributable to human activities”.

A small minority of qualified scientists contests the view that humanity's actions have played a significant role in increasing recent temperatures. Uncertainties do exist regarding how much climate change should be expected in the future, and a hotly contested political and public debate exists over what actions, if any, should be taken in light of global warming.

Based on basic science, observational sensitivity studies, and the climate models referenced by the IPCC, temperatures may increase by 1.4 to 5.8° C. between 1990 and 2100. This is expected to result in other climate changes including rises in sea level and changes in the amount and pattern of precipitation. Such changes may increase the frequency of extreme weather disaster such as floods, droughts, heat waves, and hurricanes, change agricultural yields, or contribute to biological extinctions. Although warming is expected to affect the number and magnitude of these disasters, it is very difficult to connect any particular disaster to global warming.

The concentration of carbon dioxide in the atmosphere has been increasing gradually. It was 315 ppm in 1960, 325 ppm in 1970, and 335 ppm in 1980. It now stands at about 850 ppm. While this increase in the carbon dioxide concentration is considered to be caused by the total effect of various causes, such as deforestation, desertification, the destruction of coral reefs and an increase in population, because the increasing use of fossil fuel, such as coal and oil, coincides more or less with the increase in the carbon dioxide concentration over years, the release of carbon dioxide produced by the combustion of fossil fuel has been inferred as one of major causes of this increase of carbon dioxide in the atmosphere.

An increase in the atmospheric carbon dioxide will causes higher atmospheric temperatures, the warming of climate and greenhouse effects of the earth. As a result, the melting of Antarctic ice, a rise in oceanic temperature, the rise of sea levels, desertification, food shortage and so on might occur in the future, and the future of mankind might well be endangered. If we keep burning fossil fuel and releasing carbon dioxide in the exhaust gas without any treatment, the carbon dioxide concentration in the atmosphere will most certainly increase further.

In order to prevent this increase in the carbon dioxide concentration, the following methods have been reported for disposing carbon dioxide without releasing it into atmosphere and for disposing carbon dioxide collected from the atmosphere:

(1) Carbon dioxide is dissolved into seawater and disposed in the ocean. The seawater which has dissolved carbon dioxide has a larger specific gravity and therefore goes down to the bottom of sea.

(2) Because liquid carbon dioxide has a larger specific gravity than the normal seawater and the temperature of the deep sea at a depth of more than 3,000 m, carbon dioxide can be disposed in the ocean at that depth as liquid carbon dioxide.

According to method (1), however, the seawater which has dissolved carbon dioxide diffuses out to a broad area with ocean flow and may affect the ecological system of oceanic life. Also, according to method (2), it takes a large amount of energy and equipment for maintaining temperature to liquify carbon dioxide and then to introduce it to a depth of more than 3,000 m, and in much the same way as method (1) carbon dioxide may diffuse broadly in the sea as well.

### BACKGROUND OF THE INVENTION

An international agreement to reduce an amount of carbon dioxide emission was made, because the increase of the amount of carbon dioxide causes a global warming.

The Kyoto Protocol was adopted at the meeting of COP3 (The Third Meeting of Treaty Countries of the United Nations Framework Convention on Climate Change, at Kyoto) to achieve a purpose to settle the stabilization of a density of atmospheric greenhouse effect gas.

The developed nations were imposed duty on reducing the greenhouse effect gas of the year 1990 to a certain constant numerical value (Japanese 6%, U.S. 7%, EU 8%) during the year from 2008 to 2012. This Kyoto Protocol took effect on Feb. 16, 2005. A surcharge system and an emission right trade system are suggested as proper measures to restrain carbon dioxide discharge and are going to be put into the enforcement stage.

Emissions trading is an administrative approach used to reduce the cost of pollution control by providing economic incentives for achieving emissions reductions. In such a plan, a central authority (e.g., air pollution control district, State agency, or Federal agency) sets limits or “caps” on each pollutant. Groups that intend to exceed the limits may buy emissions credits from entities that are able to stay below their designated limits. This transfer is normally referred to as a trade. (In some emission trading systems a portion of the traded credits is required to be retired. By retiring some of the credits the system achieves a net reduction in emissions, as well as cost reduction, from each trade.) Most authorities agree that emissions trading is an effective strategy if properly designed and administered.

Emissions trading or marketable rights have been in use in the United States since the mid-1970s. The advocates of free-market environmentalism sometimes use emissions trading or marketable rights systems as examples to support the theory that free markets can handle environmental problems. The total amount of available market or tradable rights is generally set by a political process, not by the market; but the systems allows the market to determine how to deal with the resulting allocation problem.

The idea is that a central authority will grant an allowance to entities based upon a measure of their need or their previous pollution history. For example an allowance for greenhouse gas emissions to a country might be based upon total population of the country or based on existing emissions of the country. An industrial facility might be granted a license for its current actual emissions. If a given country or facility does not need all of its allowance, it may offer it for sale to another organization that has insufficient allowances for its emission production.

An emission right trade system is that a country or a company which achieves a purpose of reducing the amount of carbon dioxide emission to the targeted point, can sell a certain quantity of reduction amount as an emission right (emission credit) to a country or a company which does not accomplish its targeted point and also a country or a company which is going to emit carbon dioxide beyond the previously assigned limited level.

Contracted countries or companies are assigned their dischargeable carbon dioxide amount limits that are set forth according to their current amount of carbon dioxide emission, subsequently, they have to buy emission credits from other countries or companies which have extra carbon dioxide emission right if they intend to exceed their assigned limit of emission.

On the other hand, in case of the amount of carbon dioxide emission is lower than the allowed level by using a newly developed carbon dioxide fixation technologies or the like, an excess amount of carbon dioxide emission right can be transferred to countries or companies who failed to meet their targets, and the trade of the carbon dioxide emission right is effected between the supplier and the demander.

If a trade market of a carbon dioxide emission right is established, it is expected that the technologies to reduce an amount of carbon dioxide emission or to fix and absorb carbon dioxide will be developed more widely and rapidly and also the a carbon dioxide emission right trade business will establish a big market.

In the prior arts concerning a carbon dioxide emission right trade system, it is suggested in the field of an electric power generation as disclosed in Japanese patent laid open JP 2001-306889 and JP 2004-810469.

JP 2001-306839 discloses a carbon dioxide emission right trade based on an electric power generation by solar cells. This invention is to provide a method and a system, which facilitate a trade of a carbon dioxide emission right in order to suppress discharge of carbon dioxide.

When the actual emission quantity of carbon dioxide of an entity is larger than the amount corresponding to an acquired a carbon dioxide emission right, a center instructs the entity to acquire a carbon dioxide emission right covering the excess. When the entity adopts solar power generation, a carbon dioxide discharge right corresponding to the generated electric power is given to the entity from the center. The trades of the carbon dioxide emission right are performed through the Internet. The sale price of the carbon dioxide emission right is determined in the center with the free rate system.

JP2004-310469 discloses a carbon dioxide emission right trade system, in which the third party authorized by the government or the like evaluates and certifies an amount of carbon dioxide emission reduction effect by using an alternative electric power generation means instead of using fossil fuel means.

This invention is to provide the environmental contribution certification system, which evaluates carbon emissions of power production reduced by fuel switching as an added value, comprises contribution level acquiring means for acquiring an amount of carbon emissions of power production reduced by fuel switching or an amount of business subsidies provided for a power producer.

As an environmental contribution level by numerical data, and evaluation certification issuing means for issuing an environmental contribution added value, evaluation certification is evaluating the acquired environmental contribution level as an added value to the power producer that produces power with carbon emissions reduced by fuel switching,

To guarantee the authenticity of the certificate and to prevent a forgery of the certificate, a certain registration system should be adopted and an emission right holder must be imposed the duty to register when the trade is conducted.

A generation company notifies to the evaluation organization of carbon dioxide reduced amount of discharge (a carbon dioxide emission right) by using substituted fuel, and the evaluation organization publishes a certificate of reduced amount of carbon dioxide emission to a subsidy sponsors as environmental contribution conducted by a generation company.

To provide an environmental contribution certification system, this invention discloses a market for certificating a reduction in carbon emissions by fuel switching as an emission allowance.

In Japanese Patent laid open JP 2000-262888, a carbon dioxide fixation technology using seawater is disclosed in FIG. 5, which discloses the art of reducing carbon dioxide emission by fixing and absorbing carbon dioxide in the atmosphere to a scattered seawater through a jet nozzle, which seawater is pump up from the depth of around 200 m with a solar battery.

For reducing carbon dioxide increased in the atmosphere, this invention comprises the steps of a seawater pumping-up step using a pump powered by solar cell panels and a jet nozzle and using the pump and a piping to pump up seawater to the jet nozzle from a deep sea water, a seawater sprinkling step for sprinkling pumped-up seawater over the surface of the sea from above by using the jet nozzle, a step for measuring the atmosphere of CO₂ contained in pumped-up seawater by using a seawater CO₂ content measuring device, a step for measuring the atmosphere of CO₂ contained in sprinkled seawater by using the seawater CO2 content measuring device, and an absorbed amount of CO₂ calculating step for subtracting the amount of CO₂ in sprinkled seawater from the amount of CO₂ in pumped-up seawater to calculate the amount of CO₂ taken in seawater by using an absorbed amount of CO₂ calculating sensor.

### DETAILED DESCRIPTION OF THE INVENTION

A large amount of carbon dioxide is discharged into the atmosphere indispensably as a result of industrial activities, so companies or countries discharging carbon dioxide indispensably according to their industrial activities, have to obtain a carbon dioxide emission right to continue their industrial activities.

On the other hand, in this situation, a company, which newly developed carbon dioxide fixation technology, will obtain an additional marketable value if a carbon dioxide emission trade market is established, which will be a great incentive factor for the company to finance and to develop new technologies and also contributes to improving the earth environment.

The oceans are very large and essentially have potential ability to absorb and to fix carbon dioxide by nature. It is disclosed in Japanese Patent laid open JP 2000-262888, that the potential ability of the ocean to fix carbon dioxide is increased and accelerated by pumping up the deep seawater and scattering it in atmosphere. To maintain the tidelands in proper condition or to build breakwaters increases the potential ocean ability to fix and to absorb carbon dioxide. By linking the carbon dioxide fixation technologies using seawater with the ocean related facilities, ocean environment can be conserved clean and also carbon dioxide in atmosphere is fixed at the same time.

Therefore, a carbon dioxide emission right could be created depending on an amount of carbon dioxide being fixed by developed technologies, which is considered to be an old saying, killing two birds with one stone.

Many private companies have not been active to develop technologies of carbon dioxide fixation utilizing seawater, because the sea is a public domain, and it requires a large amount of finance to construct large-scaled facilities, such as breakwaters, moreover it takes a long term to be officially evaluated as an effective technology for carbon dioxide fixation, so the private companies are reluctant to invest for sea related carbon dioxide fixation technologies.

Therefore it is necessary to build up a system including a public organization, for instance a nation, carbon dioxide discharging companies, companies studying carbon dioxide fixation technologies and investors. The system may put together the proposed technologies, marine developers, sponsors and can accelerate a progress of the carbon dioxide fixation technologies and investments.

Public organizations must be involved as a referee or a grader to evaluate the carbon dioxide fixation technologies using seawater which is developed by private companies, for guarantee the grades of the evaluation.

Present invention provides a system to manage a carbon dioxide emission right trade related to technologies using seawater smoothly and to urge private companies forward on developing carbon dioixde fixation technologies using seawater, and also investments.

A carbon dioxide emission right trade system of the present invention comprises: a database memory means which stores carbon dioxide fixation technologies using seawater with grade, technology evaluation scores, exploitable seas and areas of the ocean; and an input means of a value amount of carbon dioxide emission and a selected carbon dioxide fixation technology; and a processing means for the amount of carbon dioxide emission to calculate the product of the evaluation score and the square (measure) of land referring to above database; and a comparing means between the input data of numerical amount of emission and the product data calculated by processing means; and an output means that displays the technology of which product data is bigger than the input data.

The input means or the output means are connected to telecommunication system like an internet, and the system can be accessible from anywhere in the world where the internet system is available.

As a sea area is displayed on a map with an assigned grade to a certain technology on the input means, it is easy to entry the data into the input means with a pointing device quickly.

### BRIEF DESCRIPTION OF THE DRAWINGS

FIG. 1 is a block diagram of carbon dioxide emission system of the present invention.

FIG. 2 is a diagram of general idea of the trade market of carbon dioxide emission of the present invention.

FIG. 3 is a diagram of general idea of the banking system of carbon dioxide emission of the present invention.

FIG. 4 is a diagram of general idea of the prior arts of carbon dioxide emission trade system.

FIG. 5 is a drawing of a sample of carbon dioxide fixation technology using seawater.

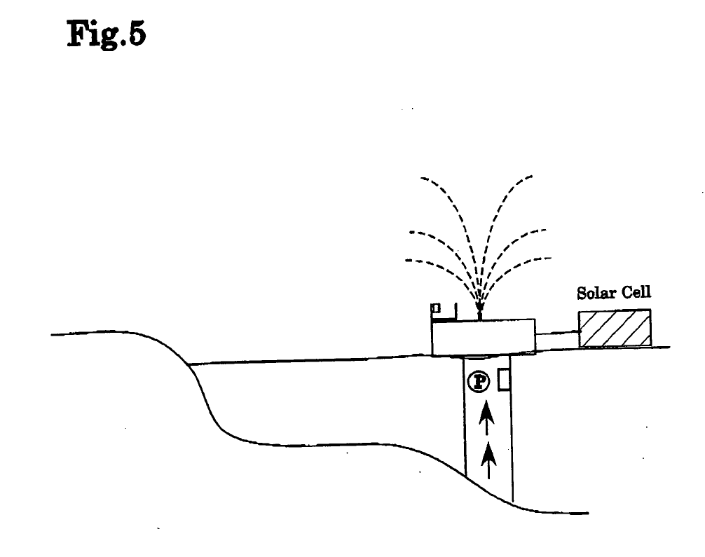

### EMBODIMENT OF THE INVENTION

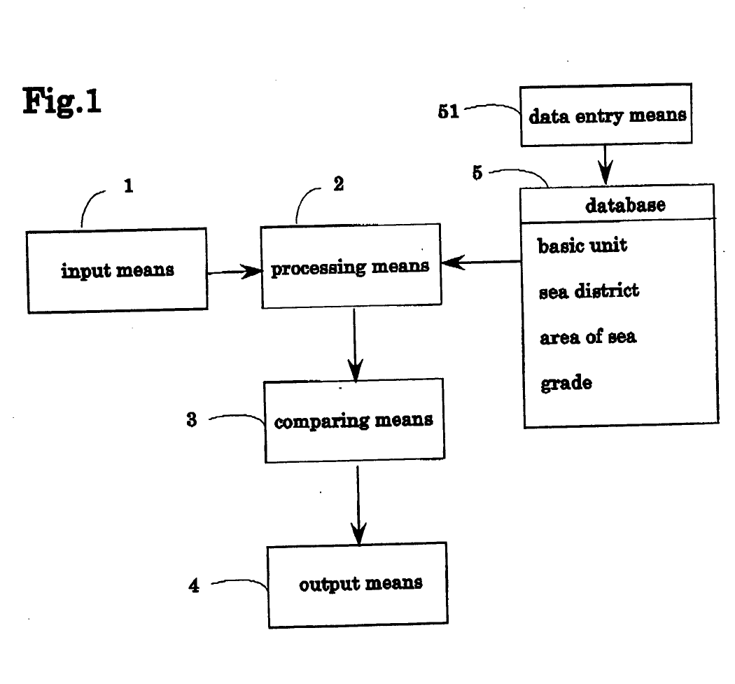

FIG. 1 is a block diagram of carbon dioxide emission right trade system of the present invention.

A carbon dioxide emission right trade system of the present invention includes an input means 1, a processing means 2, a comparing means 3, an output means 4, a database 5 and a data entry means 51.

Features of the carbon dioxide fixation technologies using seawater with evaluated grade are stored as a database 5 in memory means being input by data entry means 51. One of the examples of the technologies of the carbon dioxide fixation using seawater is a simple carbon dioxide absorption in certain sea area, absorbing carbon dioxide with coral reef by environmental conservation and also conserving environment for various species of shells, seaweeds and mangroves.

Furthermore, the database 5 includes the names of sea area where the carbon dioxide fixation technology is applicable, the area of the sea and the predicted amount of carbon dioxide fixation per area, it is called a basic unit.

An amount of carbon dioxide emission right or a proposed carbon dioxide fixation technology is entered by the input means 1, more particularly, the sea area with a map and a list of carbon dioxide fixation technologies are displayed on a monitor and an operator selects a sea area and carbon dioxide fixation technology by a pointing device. And there is also providing a column where an amount of required carbon dioxide emission right is input by a keyboard.

The processing means 2 begins calculation according to a stored program. A multiple of the selected sea area and the basic unit stored in the database 6 is calculated by the processing means 2, and a result is displayed on the monitor as an available amount of carbon dioxide to be fixed.

A comparing means 3 is programmed to compare the calculated result with an amount of carbon dioxide emission entered. A comparing result is output in a predetermined format on the monitor by the output means 4.

A reliability of the database is highly important, an evaluation of carbon dioxide fixation technology, a selection of applicable sea area and the amount of carbon dioxide fixation per area (basic unit) should be decided and authorized by the third party sponsored by public organization.

Because a fair judgment concerning a carbon dioxide fixation technology application at the sea depends on the data and the evaluation decision of the basic unit is judged according to the data. Also, it is preferable to recalculate precisely the amount of carbon dioxide fixation by setting up the basic unit more specific at every sea area, as carbon dioxide fixation technology depends on the sea condition and the basic unit may change as the sea environment changes,

The input means and output means of the present invention are connected to a telecommunication device such as Internet, it makes possible to input/output data remotely. If necessary, passwords might be registered to restrict the access.

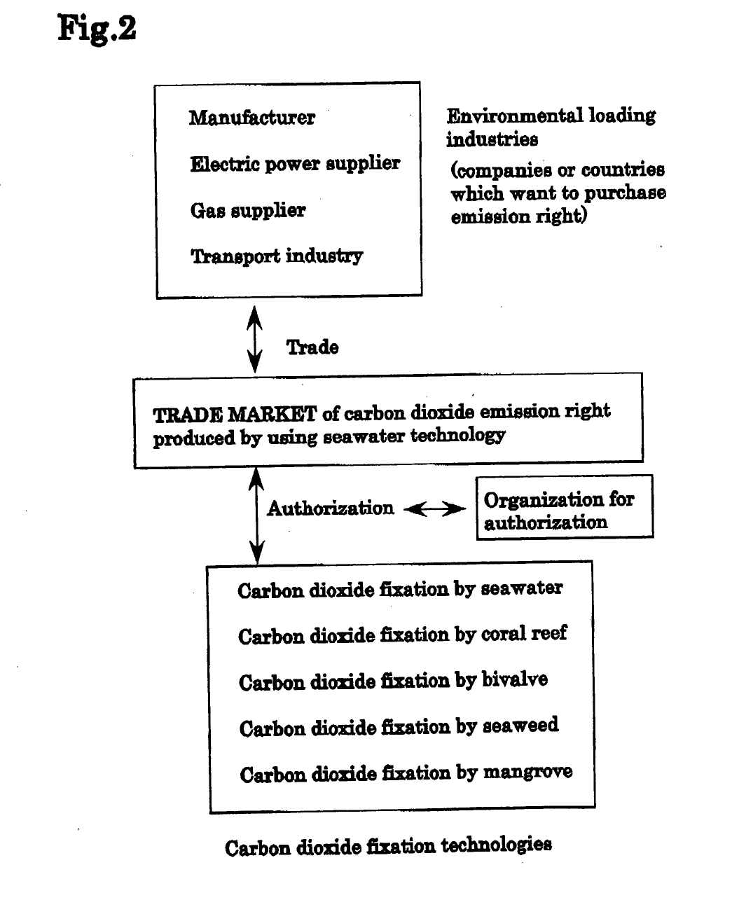

FIG. 2 is a diagram of general idea of the trade market where the trade system of the present invention applied, in which carbon dioxide emission technologies using seawater are conducted, for example, the technology to activate the carbon dioxide fixation ability of the ocean, the technology of an atmospheric carbon dioxide fixation to a coral by breeding coral reef, the technology of carbon dioxide fixation by building a breeding space for bivalve, the technology of carbon dioxide fixation by building a breeding space for seaweed and the technology of carbon dioxide fixation by flourishing mangrove.

The third authorized organization decides the basic unit of carbon dioxide fixation amount of the ocean according to the technology. The data of basic unit is stored to the database of the trade system of the market of carbon dioxide emission. The environmentally loading industries or countries may purchase the carbon dioxide emission right through the trading market. The present invention makes it possible to trade easily the carbon dioxide emission of certain sea area and certain carbon dioxide fixation technology in an auction form by connecting to the management device and trading device.

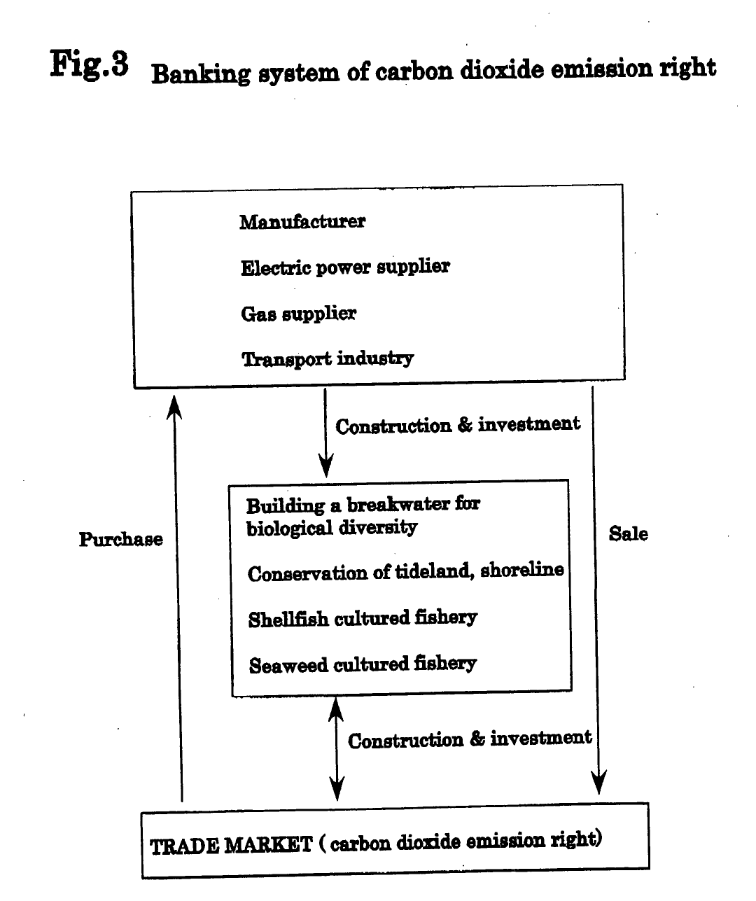

Not only environmentally loading industries obtains the current carbon dioxide emission right by trade, but also they can obtain the right by investing to the construction business, which produces the future carbon dioxide emission right using seawater technology showing in FIG. 3. It will be possible to acquire the carbon dioxide emission right in return of the environmental investment, and rousing investment will of the company makes the emission trade amount increase, also the environment is improved by maintaining tideland, shoreline as a carbon dioxide fixation technology is carried out in reality.

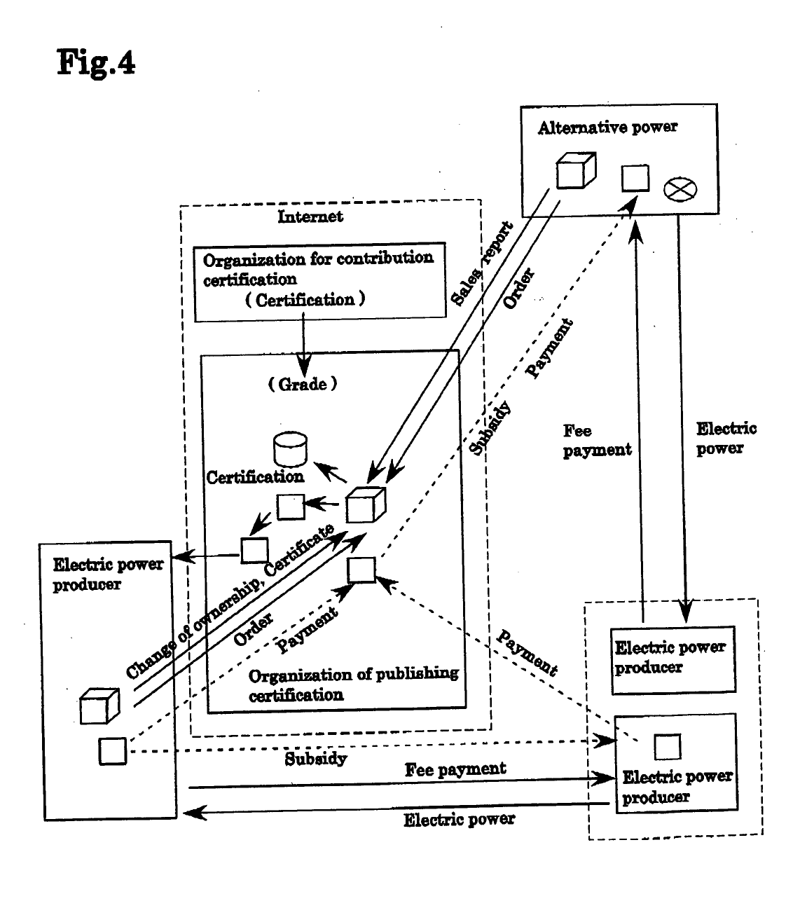

The trade system of this invention is connected to Internet as shown in FIG. 4, and the carbon dioxide emission right buyers can choose a proper technology according to their necessary amount of carbon dioxide emission right. As the third authorized organization evaluated an amount of carbon dioxide emission right with respect to every technology, and the technology database is available in every sea district, so it is easy for the buyers to determine which technology should be chosen for investment, considering a probability of realization of the selected technology and a future necessary carbon dioxide emission right.

During a process of realization of emission technology, entities may obtain more amount of carbon dioxide emission than set forth beforehand because the technology is always progressed during the process, so it may make the basic unit of an amount of carbon dioxide fixation increased. The surplus emission may be returned to investors as a bonus.

As for the example of the present invention, a local government can file the application to the national government concerning the special local area wherein the carbon dioxide fixation technology is available evaluated by the present invention, it may arouse private companies will to make investment to construction business.

The present invention makes it possible to build a united circulation system, which comprises developers of a carbon dioxide fixation technology using seawater, public organizations or a countries and companies which emit carbon dioxide. It also makes the technology development and marine development progressed by gathering the fund intensively.

In addition, the present invention promotes the carbon dioxide emission trade by carbon dioxide fixation technology using seawater, and raise the business will to develop carbon dioxide fixation technology and a construction investment.

### SUMMARY OF THE INVENTION

The present invention intends to promote a carbon dioxide emission trade and research and development on carbon fixation technologies using seawater.

A Carbon dioxide emission trade system of the present invention includes: a database memory means 5 which stores; grade classification type of carbon dioxide fixation technology using seawater, a name of the sea area where the technology is available, a square of ocean, an amount of carbon dioxide fixation per unit area (a basic unit); and an entry means 51 for entering above data; and an input means 1 for entering an amount of carbon dioxide emission or a name of sea area or a selected carbon dioxide fixation technology; and an processing means 2; for calculating a product of square of ocean and basic unit according to a data entered by input means 1, referred to the database 5; and a comparing means 3 that compares the input data 1 of an amount of emission and the product data of processing means 2; and an output means 4 indicating a results of comparison.

By setting an amount of carbon dioxide fixation per unit area (basic unit) using seawater technology in every specific small area, it makes the product data of calculation more precisely, further, as input means and output means are connected to telecommunication line such as Internet, it can be available to use this system anywhere.

1. A carbon dioxide emission right trade system comprising:
a database memory means storing carbon dioxide fixation technologies using seawater with evaluated grades, technology evaluation scores, exploitable seas and their area;
an input means for entering a value amount of carbon dioxide emission and a selected carbon dioxide fixation technology and a name of sea area;
a processing means for calculating an amount of carbon dioxide emission product of evaluation score and an area of selected sea area referring to a database;
a comparing means for comparing an input amount of carbon dioxide emission with a calculated result by a processing means, and an output means displaying a result of a comparison conducted by a comparing means.

2. A carbon dioxide emission right trade system according to claim 1 wherein the input means or the output means are connected to a telecommunication system.

3. A carbon dioxide emission right trade system according to claim 1 wherein the input means displays carbon dioxide fixation technologies and sea areas in a form of a map, selecting a technology and sea area by a pointing device.

4. A carbon dioxide emission right trade system according to claim 1 wherein the output means displays a calculated result in a descend manner with respect to a calculated amount of fixed carbon dioxide.

5. A carbon dioxide emission right trade system according to claim 1 wherein the output means displays a calculated result in a descend manner with respect to sea area.
